(19) United States
(12) Patent Application Publication
(10) Pub. No.: US 2006/0063886 A1
(43) Pub. Date: Mar. 23, 2006

(54) Latex with surface properties modified by addition of a water-soluble copolymer amphiphilic in nature

(76) Inventors: Jean-Christophe Castaing, Paris (FR); Jean-Francois D'Allest, Mulhouse (FR); William Bett, Paris (FR)

Correspondence Address: Jean-Louis Seugney;Intellectual Property Dept., Rhodia Inc., 259 Prospect Plains Road, CN 7500, Cranbury, NJ, 08512-7500, US

(21) Appl. No.: 11/266,554

(22) Filed: Nov. 3, 2005

Related U.S. Application Data
(63) Continuation of application No. 10/380,319, filed on Aug. 8, 2003.

(30) Foreign Application Priority Data
Sep. 18, 2000 (FR) 00/11,875

(51) Int. Cl. C08L 51/00

(52) U.S. Cl. 525/70

(57) ABSTRACT

The Invention concerns a latex with modified surface properties obtainable by a method which consists in adding a water soluble amphiphilic copolymer in a aqueous dispersion of a water-insoluble polymer obtained from ethylenically unsaturated monomers.

The present invention relates to a latex with surface properties modified by addition of a water-soluble copolymer amphiphilic in nature.

Latexes are products well known to those skilled in the art. They consist of aqueous dispersions of water-insoluble polymers. These fluid systems contain, as dispersed phase, particles of polymers consisting of several entangled polymer chains in an aqueous dispersion medium. The diameter of the polymer particles within the dispersion can range between 10 and 5 μm. These latexes find many applications, in particular as additives in formulations for paints, for paper (coating mixtures, bulk paper) or in formulations intended to be applied in the building industry (adhesive, bonding agents, smoothing coatings, etc.). They impart important properties on these formulations by virtue, for example, of their binding power, their film-forming power and their ability to impart particular rheological properties.

In general, for all the applications of latexes, it is sought to reconcile good colloidal stability of the aqueous formulations before drying, and good mechanical properties after drying.

One aim of the present invention is to provide a novel latex with modified surface properties.

This aim, and others which will become apparent on reading the description, are achieved by the present invention, the subject of which is a latex with modified surface properties, which can be obtained using a method which comprises addition of a water-soluble amphiphilic copolymer to an aqueous dispersion of a water-insoluble polymer or copolymer obtained from monomers with ethylenic unsaturation.

These latexes exhibit an improved colloidal stability in the formulation. They are in particular intended to be used as binding agents in various applications in the fields of paint, papermaking coating, coatings and construction materials.

In the context of the present invention, the term “water-soluble copolymer” is intended to mean a copolymer which, when it is brought into contact with water, spontaneously forms a solution which tends to homogenize. If the mixture is left for several days with gentle agitation, any sample taken from any place in the volume occupied by the sample gives the same concentration value as the mean concentration value. Included in this definition are not only completely soluble copolymers, but also copolymers which form a homogeneous solution having a slight turbidity due to local aggregation of the copolymer.

The term “amphiphilic copolymer” refers to a copolymer obtained by polymerization of hydrophilic monomers and hydrophobic monomers; this copolymer comprises hydrophobic segments and hydrophilic segments and, as a result, exhibits different regions of solubility in water.

According to a first embodiment, the water-soluble amphiphilic copolymer is a random polymer obtained by copolymerization of hydrophilic monomers and hydrophobic monomers. Such a copolymer randomly comprises hydrophilic units and hydrophobic units, the number of hydrophilic units being greater than the number of hydrophobic units. According to a particular embodiment, the amphiphilic copolymer is obtained by polymerization of hydrophobic monomers so as to form hydrophobic units which are subsequently at least partially hydrolyzed so as to form hydrophilic units. According to a different embodiment, the amphiphilic copolymer is obtained from hydrophobic monomers and hydrophilic monomers, the hydrophilic units obtained being able to be subsequently hydrolyzed so as to form other hydrophilic units.

According to a second embodiment, the water-soluble amphiphilic copolymer is a block copolymer which contains at least one block which is hydrophilic in nature and one block which is hydrophobic in nature.

In the following description, the expression “block which is hydrophilic in nature” is intended to mean a water-soluble block polymer comprising hydrophilic units in a proportion of greater than 25% by weight relative to the total number of mols of units in the block which is hydrophilic in nature, and hydrophobic units preferably representing less than 20% by weight. The term “unit” is intended to mean the part of the block corresponding to a monomer unit. According to a particular embodiment, the block which is hydrophilic in nature comprises only hydrophilic units.

Similarly, the expression “block which is hydrophobic in nature” is intended to mean a water-insoluble block polymer comprising mainly hydrophobic units (at least 50% by weight of hydrophobic units relative to the weight of units of the block which is hydrophobic in nature), and hydrophilic units preferably representing less than 20% by weight of the block. According to a particular embodiment, the block which is hydrophobic in nature comprises only hydrophobic units.

According to a first variant, the water-insoluble amphiphilic copolymer containing a block which is hydrophilic in nature and a block which is hydrophobic in nature is obtained by polymerization of hydrophobic monomers and hydrophilic monomers. The content of hydrophilic and hydrophobic units in each of the blocks depends on the content of hydrophilic and hydrophobic monomers at the time of polymerization and on the sequence of addition of these monomers.

According to a second variant, the water-soluble amphiphilic block copolymer is obtained by polymerization of hydrophobic monomers which can be made hydrophilic by hydrolysis, and optionally of hydrophobic monomers which are resistant to the conditions for hydrolysis of the other monomers and/or of hydrophilic monomers. The polymer obtained is subsequently hydrolyzed so as to obtain the water-soluble amphiphilic block copolymer. During the hydrolysis, the hydrophobic units corresponding to the hydrolyzable monomers are converted to hydrophilic units. By introducing the monomers into the polymerization medium in an appropriate manner, a copolymer containing, after hydrolysis, a block which is hydrophilic in nature and a block which is hydrophobic in nature is obtained. The amounts of hydrophilic and hydrophobic units in each of said blocks are then controlled by the amount of each type of monomer and by the degree of hydrolysis. It is thus possible to envision the formation of a water-soluble amphiphilic copolymer from hydrophobic monomers and hydrophilic monomers, the hydrophilic units thus obtained being able to be hydrolyzed to other hydrophilic units.

According to this second variant, the water-soluble amphiphilic copolymer containing a block which is hydrophilic in nature and a block which is hydrophobic in nature can be obtained by homopolymerization of hydrophobic monomers which can be made hydrophilic by hydrolysis. The copolymerization is then followed by partial hydrolysis of the homopolymer obtained. The water-soluble amphiphilic copolymer containing a block which is hydrophilic in nature and a block which is hydrophobic in nature can also be obtained by copolymerization of hydrophobic monomers which can be made hydrophilic by hydrolysis and of hydrophobic monomers which cannot be made hydrophilic by hydrolysis, the copolymerization being followed by total or partial hydrolysis of the polymer obtained. According to this embodiment, the amount of hydrophilic and hydrophobic units depends on two criteria: the contents of the various types of monomer and the degree of hydrolysis. If the hydrolysis is total, it is sufficient to adjust the content of monomers. If the hydrolysis is partial, it is possible to adjust both the content of monomers and the degree of hydrolysis. According to a different embodiment, the blocks can be obtained by copolymerization of hydrophobic monomers which can be made hydrophilic by hydrolysis and of hydrophilic monomers, followed by partial hydrolysis of the polymer obtained.

In all the preceding embodiments, the degree of hydrolysis and the content of hydrophilic and hydrophobic units in each of the blocks are defined so as to obtain a water-soluble amphiphilic copolymer containing a block which is hydrophilic in nature and a block which is hydrophobic in nature as defined above, in particular as regards the presence of hydrophilic units in the block which is hydrophobic in nature and the presence of hydrophobic units in the block which is hydrophilic in nature.

The hydrophobic monomers used for the present invention can be chosen from:
vinylaromatic monomers such as styrene, and styrene derivatives such as alpha-methylstyrene or vinyltoluene,
ethylenic monomers such as ethylene, alpha-olefins, vinyl chloride,
dienes such as butadiene, isoprene,
alkyl acrylates and methacrylates in which the alkyl group contains from 1 to 10 carbon atoms, such as methyl, ethyl, n-butyl, 2-ethylhexyl, tert-butyl, isobornyl, phenyl and benzyl acrylates and methacrylates and fluoromonomers,
vinyl monomers such as vinyl acetate, vinyl versatate and nitrites, more particularly those containing from 3 to 12 carbon atoms, such as acrylonitrile and methacrylonitrile.

Preferably, the hydrophobic monomer is styrene or a styrene derivative.

The hydrophilic monomers which are of use for the present invention can be chosen from:
carboxylic acids containing ethylenic unsaturation, such as acrylic and methacrylic acid,
neutral hydrophilic monomers, such as acrylamide and derivatives thereof (n-methylacrylamide, n-isopropylacrylamide), methacrylamide, polyethylene glycol methacrylate and acrylate, hydroxyethyl methacrylate, hydroxyethyl acrylate,
anionic hydrophilic monomers: sodium 2-acrylamido-2-methylpropanesulfonate (AMPS), sodium styrenesulfonate, sodium vinylsulfonate, vinylphosphonic acid, (meth)acrylic esters of phosphoric acid,
vinyl alcohols.

The hydrophobic monomers which can be made hydrophilic by hydrolysis or the hydrophilic monomers which can be converted into other hydrophilic monomers by hydrolysis can be chosen from:
acrylates and methacrylates which can be hydrolyzed to acid, such as methyl acrylate, ethyl acrylate, tert-butyl acrylate,
vinyl acetate which can be hydrolyzed to vinyl alcohol units,
quarternized 2-dimethylaminoethyl methacrylate and acrylate (madamquat and adamquat),
acrylamide and (meth)acrylamide.

According to a particular embodiment, the water-soluble amphiphilic copolymers according to the invention are diblock copolymers consisting of a block which is hydrophilic in nature and a block which is hydrophobic in nature. However, they may also be triblock, or even multiblock, copolymers. If the copolymer comprises three blocks, it is preferable to have the following block distribution: hydrophilic-hydrophobic-hydrophilic.

According to the preferred embodiment of the invention, the water-soluble amphiphilic copolymer is a diblock copolymer comprising a block which is mainly hydrophilic in nature and a block which is mainly hydrophobic in nature, in which the block which is mainly hydrophilic in nature comprises at least 80% by weight of acrylic acid (AA) and/or methacrylic acid (MAA) units relative to the total weight of the hydrophilic block, and the block which is mainly hydrophobic in nature comprises at least 80% by weight of styrene (St) units relative to the total weight of the hydrophobic block.

The block which is mainly hydrophilic in nature may also comprise, in addition to the (AA) and/or (MAA) units, hydrophobic units such as ethyl acrylate (EtA). The block which is mainly hydrophobic in nature may comprise, in addition to the styrene (St) units, hydrophilic units such as units obtained from methacrylic acid (MAA) and/or from hydroxyethyl methacrylate (HEMA).

According to a particular embodiment, the block which is mainly hydrophilic in nature is derived:
from the polymerization of acrylic acid (AA) and of ethyl acrylate (EtA) in an EtA/AA ratio by weight of 95/5,
and then from the hydrolysis of the polymer obtained to a degree of at least 80 mol %.

Preferably, the block which is mainly hydrophobic in nature is derived from the polymerization of a mixture of monomers comprising at least 80% by weight of styrene.

According to the invention, the water-soluble amphiphilic block copolymers exhibit a molecular mass ranging between 10 000 and 30 000 g/mol. The molar masses are measured by steric exclusion chromatography in THF, using polystyrene as a standard.

According to a preferred embodiment, the block copolymer which is of use in the context of the invention is a non-surfactant copolymer. In the context of the invention, a copolymer is non-surfactant if it has a weak influence on the water/air surface tension, that is to say a solution of copolymer at 1% in water leads to a water/air surface tension of greater than 60 mN/m, for a measurement made 1 hour or less after mixing, whereas, under the same conditions, conventional surfactants exhibit a water/air surface tension at equilibrium of the order of 30-35 mN/m.

According to this embodiment, a non-surfactant copolymer can be obtained through the choice of monomers, for example the (AA)/St copolymer is non-surfactant. It is also possible to obtain a non-surfactant block copolymer by increasing the molecular mass or by decreasing the fraction of hydrophobic monomers in the copolymer.

In general, the water-soluble amphiphilic block copolymers described above can be obtained by any polymerization process referred to as “living” or “controlled”, such as, for example:
free-radical polymerization controlled by xanthates, according to the teaching of application WO 98/58974,
free-radical polymerization controlled by dithioesters, according to the teaching of application WO 97/01478,
polymerization using nitroxide precursors, according to the teaching of application WO 99/03894,
free-radical polymerization controlled by dithiocarbamates, according to the teaching of application WO 99/31144,
atom transfer free-radical polymerization (ATRP), according to the teaching of application WO 96/30421,
free-radical polymerization controlled by iniferters, according to the teaching of Otu et al., Makromol. Chem. Rapid. Commun., 3, 127 (1982),
free-radical polymerization controlled by iodine degenerative transfer, according to the teaching of Tatemoto et al., Jap. 50, 127, 991 (1975), Daikin Kogyo Co ltd Japan and Matyjaszweski et al., Macromolecules, 28, 2093 (1995),
group transfer polymerization, according to the teaching of O. W. Webster “Group Transfer Polymerization”, p. 580-588 of the Encyclopedia of Polymer Science and Engineering”, vol. 7 and H. F. Mark, N. M. Bikales, C. G. Overberger and G. Menges, Eds., Wiley Interscience, New York, 1987,
free-radical polymerization controlled by tetraphenylethane derivatives (D. Braun et al. Macromol. Symp. 111, 63 (1996)),
free-radical polymerization controlled by organocobalt complexes (Wayland et al. J. Am. Chem. Soc. 116, 7973 (1994)).

According to a preferred embodiment, the water-soluble amphiphilic block copolymer of the invention is prepared by living free-radical polymerization using dithioesters, thioethers-thiones, dithiocarbamates or xanthates. This living free-radical polymerization process consists in bringing into contact at least one ethylenically unsaturated monomer, at least one source of free radicals, and a dithioester, thioether-thione, dithiocarbamate or xanthate compound, and in initiating the polymerization thermally.

In order to obtain water-soluble amphiphilic copolymers comprising hydrophilic and hydrophobic blocks, this process consists in forming a first block according to the following steps:
1• bringing into contact:
   at least one ethylenically unsaturated monomer,
   at least one source of free radicals, and
   at least one compound of formula (I):
      S═C(Z¹¹(R¹¹)ₓ)—S—R¹² (I)
in which:
   Z¹¹ represents C, N, O, S or P,
   R¹¹ and R¹², which may be identical or different, represent:
      (i) an optionally substituted alkyl, acyl, aryl, alkene or alkyne group,
      (ii) an optionally substituted, saturated or unsaturated, dr aromatic, carbon-based ring,
      (iii) an optionally substituted, saturated or unsaturated, or aromatic, heterocycle,
   x corresponds to the valency of Z¹¹ or x equals 0 and, in this case, Z¹¹ is R¹¹;
2• forming a second block by repeating step 1 using:
   monomers which are different in nature, and
   in place of the precursor compound of formula (I), the polymer derived from step 1, and
3• optionally hydrolyzing, at least partially, the copolymer obtained.

During step 1, a first block of the polymer is synthesized which is mainly hydrophilic or hydrophobic in nature depending on the nature and the amount of the monomers used. During step 2, the other block of the polymer is synthesized.

The ethylenically unsaturated monomers will be chosen from the hydrophilic, hydrophobic and hydrolyzable monomers defined above, in proportions suitable for obtaining a block copolymer in which the blocks exhibit the characteristics defined above.

According to this process, if all the successive polymerizations are carried out in the same reactor, it is generally preferable for all the monomers used in a step to be consumed before the polymerization of the subsequent step begins, therefore before the new monomers are introduced. However, it may so happen that the hydrophobic or hydrophilic monomers of the preceding step are still present in the reactor during the polymerization of the subsequent block. In this case, these monomers generally represent no more than 5 mol % of all the monomers and they participate in the polymerization by contributing to the introduction of the hydrophobic or hydrophilic units into the subsequent block.

A water-soluble amphiphilic copolymer comprising blocks which are hydrophilic in nature and which are hydrophobic in nature can be obtained from a single type of hydrophobic hydrolyzable monomer. In this case, step 2 is no longer necessary, but partial hydrolysis of the polymer is then essential.

Using the same process, it is possible to obtain a copolymer comprising n blocks by repeating the preceding steps 1 and 2, but replacing the compound of formula (I) with the copolymer comprising n−1 blocks.

For further details regarding the preceding polymerization process, reference may be made to the content of application WO 98/58974.

Using this process, a water-soluble amphiphilic copolymer is obtained which corresponds to the following formula:
S═C(Z¹¹(R¹¹)ₓ)—S-[A]-R¹² (Ip)
in which:
Z represents C, N, O, S or P,
R¹¹ and R¹², which may be identical or different, represent:
   (i) an optionally substituted alkyl, acyl, aryl, alkene or alkyne group, or
   (ii) an optionally substituted or aromatic, saturated or unsaturated, carbon-based ring, or
   (iii) an optionally substituted, saturated or unsaturated, heterocycle,
x corresponds to the valency of Z¹¹ or x equals 0 and, in this case, Z¹¹ is R¹¹;
A represents a polymer chain comprising a block which is hydrophilic in nature and a block which is hydrophobic in nature.

According to an advantageous variant of the invention, the compound of formula (I) is such that Z¹¹ is an oxygen atom. Such compounds are functionalized at the end of the chain with the xanthates.

According to a second embodiment of the invention, use is made, as a water-soluble amphiphilic copolymer, of a copolymer corresponding to the following formulae: 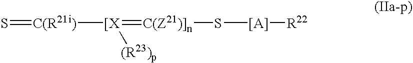
and/or: 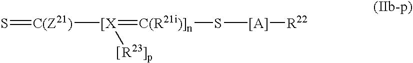
in which formulae:
X represents an atom chosen from N, C, P or Si,
R²² represents:
   (i) an optionally substituted alkyl, acyl, aryl, alkene or alkyne group,
   (ii) an optionally substituted, saturated or unsaturated, or aromatic, carbon-based ring,
   (iii) an optionally substituted, saturated or unsaturated, or aromatic, heterocycle,
Z²¹, R²¹ⁱ and R²³, which may be identical or different, are chosen from:
   a hydrogen atom
   an optionally substituted alkyl, acyl, aryl, alkene or alkyne group,
   an optionally substituted, saturated or unsaturated, or aromatic, carbon-based ring,
   an optionally substituted, saturated or unsaturated, heterocycle,
   alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl or organosilyl groups, R representing an alkyl or aryl group,
   groups exhibiting a hydrophilic or ionic nature, such as alkali metal salts of carboxylic acids, alkali metal salts of sulfonic acid, poly(alkylene oxide) (PEO, PPO) chains or cationic substituents (quaternary ammonium salts),
n>0,
i ranges from 1 to n,
p equals 0, 1 or 2 depending on the valency of X in addition,
if X═C, then Z²¹ is not an S-alkyl or S-aryl group,
the group R²¹ⁱ, with i=n, is not an S-alkyl or S-aryl group,
A represents a polymer chain comprising a block which is hydrophilic in nature and a block which is hydrophobic in nature.

These water-soluble amphiphilic block copolymers can be obtained using the process described above, in which the compound of the formula (I) is replaced with one of the compounds described below:

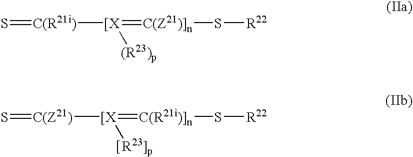

According to a third embodiment of the invention, the water-soluble amphiphilic block copolymer corresponds to the following formula: 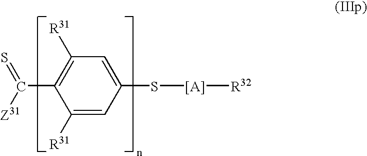
in which formula:
X represents an atom chosen from N, C, P or Si,
R³² represents:
   (i) an optionally substituted alkyl, acyl, aryl, alkene or alkyne group,
   (ii) an optionally substituted, saturated or unsaturated, or aromatic, carbon-based ring,
   (iii) an optionally substituted, saturated or unsaturated, or aromatic, heterocycle,
Z³¹ is chosen from:
   a hydrogen atom,
   an optionally substituted alkyl, acyl, aryl, alkene or alkyne group,
   an optionally substituted, or aromatic, saturated or unsaturated, carbon-based ring,
   an optionally substituted, saturated or unsaturated, heterocycle,
   alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl or organosilyl groups, R representing an alkyl or aryl group,
   groups exhibiting a hydrophilic or ionic nature, such as alkali metal salts of carboxylic acids, alkali metal salts of sulfonic acid, poly(alkylene oxide) (PEO, PPO) chains or cationic substituents (quaternary ammonium salts),
R³¹ is Z³¹ or a group SR³²,
n>0,
A represents a polymer chain comprising a block with a hydrophilic nature and a block with a hydrophobic nature.

These water-soluble amphiphilic copolymers can be obtained using the process described above, in which the compound of formula (I) is replaced with the compound described below: 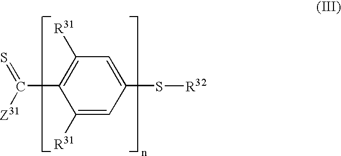
in which R³¹, R³² and Z³¹ are as defined above.

According to a fourth embodiment of the invention, the water-soluble amphiphilic block copolymer corresponds to formula (IVp) below
S═C(Z⁴¹)-[C≡C]ₙ—S-[A]-R⁴¹
in which:
R⁴¹ represents:
   (i) an optionally substituted alkyl, acyl, aryl, alkene or alkyne group,
   (ii) an optionally substituted, saturated or unsaturated, or aromatic, carbon-based ring,
   (iii) an optionally unsubstituted, saturated or unsaturated, or aromatic, heterocycle,
Z⁴¹ represents:
   a hydrogen atom,
   an optionally substituted alkyl, acyl, aryl, alkene or alkyne group,
   an optionally substituted, or aromatic, saturated or unsaturated, carbon-based ring,
   an optionally substituted, saturated or unsaturated, heterocycle,
   alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl or organosilyl groups, R representing an alkyl or aryl group,
   groups exhibiting a hydrophilic or ionic nature, such as alkali metal salts of carboxylic acids, alkali metal salts of sulfonic acid, poly(alkylene oxide) (PEO, PPO) chains or cationic substituents (quaternary ammonium salts),
n>0,
A represents a polymer chain comprising a block which is hydrophilic in nature and a block which is hydrophobic in nature.

These water-soluble amphiphilic copolymers can be obtained using the process described above, in which the compound of formula (I) is replaced with the compound described below of formula (IV):
S═C(Z⁴¹)-[C≡C]ₙ—S—R⁴¹
in which Z⁴¹ and R⁴¹ are as defined in formula (IVp).

According to a fifth embodiment of the invention, the water-soluble amphiphilic copolymer corresponds to the following formula:
S═C(OR⁵¹)—S-[A]-R⁵² (Vp)
in which:
R⁵¹ represents: 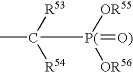
in which:
   R⁵³, R⁵⁴, which may be identical or different, are chosen from halogen, ═O, ═S, —NO₂, —SO₃R, NCO, CN, OR, —SR, —NR₂, —COOR, O₂CR, —CONR₂ and —NCOR₂ groups, with R representing a hydrogen atom or an alkyl, alkenyl, alkynyl, cycloalkenyl or cycloalkynyl radical, an aryl radical optionally condensed with an aromatic or nonaromatic heterocycle, or an alkylaryl, aralkyl or heteroaryl radical; these radicals can optionally be substituted with one or more groups, which may be identical or different, chosen from halogens, ═O, ═S, OH, alkoxy, SH, thioalkoxy, NH₂, mono- or dialkylamino, CN, COOH, ester, amide and CF₃, and/or optionally interrupted by one or more atoms chosen from O, S, N and P; or from a heterocyclic group optionally substituted with one or more groups as defined above; or R⁵³ and R⁵⁴ form, together with the carbon atom to which they are attached, a hydrocarbon-based ring or a heterocycle;
   R⁵⁵, R⁵⁶, which may be identical or different, represent a group as defined above for R; or together form a C₂-C₄ hydrocarbon-based chain optionally interrupted by a hetero atom chosen from O, S and N;
R⁵² has the same definition as that given for R⁵³;
A represents a polymer chain comprising a block which is hydrophilic in nature and a block which is hydrophobic in nature.

According to a preferred variant, the groups R⁵³ are chosen from —CF₃, —CF₂CF₂CF₃, CN and NO₂.

Advantageously, R⁵⁴ represents a hydrogen atom.

The radicals R⁵⁵ and R⁵⁶, which may be identical or different, represent an alkyl radical, preferably a C₁-C₆ alkyl radical.

These water-soluble amphiphilic copolymers can be obtained using the method as described above, in which the compound of formula (I) is replaced with one of the compounds described below:
S═C(OR⁵¹)—S—R⁵² (V-1)
R⁵¹—(O—C(═S)—R⁵²)p (V-2)
R⁵¹—(S—C(═S)—O—R⁵¹)p (V-3)
in which R⁵¹ and R⁵² are as defined in formula (Vp) and p represents an integer of between 2 and 10.

All the groups and rings (i), (ii) and (iii) and radicals which are substituted, described above, can be substituted with groups chosen with substituted phenyls, substituted aromatic groups or alkoxycarbonyl or aryloxycarbonyl (—COOR), carboxy(—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidino, hydroxy (—OH), amino (—NR₂), halogen, allyl, epoxy, alkoxy (—OR), S-alkyl or S-aryl groups, the groups exhibiting a hydrophilic or ionic nature, such as alkali metal salts of carboxylic acids, alkali metal salts of sulfonic acid, poly(alkylene oxide) (PEO, PPO) chains or cationic substituents (quaternary ammonium salts), R representing an alkyl or aryl group.

The copolymers obtained by the processes described above generally exhibit a polydispersity index of at most 2, preferably of at most 1.5.

It may be desired to mix with the latex blocks whose polydispersity is controlled. In this case, it is possible to mix, in precise proportions, several water-soluble amphiphilic copolymers comprising a block which is hydrophilic in nature and a block which is hydrophobic in nature, each having a clearly defined molecular mass.

When hydrolyzable hydrophobic monomers are used, the hydrolysis may be carried out using a base or an acid. The base can be chosen from alkali metal or alkaline earth metal hydroxides, such as sodium hydroxide or potassium hydroxide, alkali metal alkoxides, such as sodium methoxide, sodium ethoxide, potassium methoxide, potassium ethoxide or potassium t-butoxide, ammonia and amines, such as triethylamines. The acids can be chosen from sulfuric acid, hydrochloric acid and para-toluenesulfonic acid. Use may also be made of an ion-exchange resin or an ion-exchange membrane of the cationic or anionic type. The hydrolysis is generally carried out at a temperature of between 5 and 100° C., preferably between 15 and 90° C.

Preferably, after hydrolysis, the block copolymer is washed, for example by dialysis against water or using a solvent such as alcohol. It may also be precipitated by lowering the pH below 4.5.

The hydrolysis may be carried out on a single-block polymer, which will subsequently be associated with other blocks, or on the final block polymer.

The latex of the present invention comprises, in dispersion, a water-insoluble polymer obtained from monomers comprising ethylenic unsaturation. All the monomers which had been mentioned in the context of the definition of the water-soluble amphiphilic copolymer can be used as monomers comprising ethylenic unsaturations involved in the production of the latex. Reference may therefore be made to this part of the description for choosing a useful monomer comprising ethylenic unsaturation.

Among these monomers, mention may most particularly be made of those corresponding to the following formula:
CXdX′d(═CVd-CV′d)ₜ═CH₂
in which
Xd and X′d, which may be identical or different, represent: H, an alkyl group or a halogen,
Vd and V′d, which may be identical or different, represent H, a halogen or an R, OR, OCOR, NHCOH, OH, NH₂, NHR, N(R)₂, (R)₂N⁺O⁻, NHCOR, CO₂H, CO₂R, CN, CONH₂, CONHR or CONR₂ group, in which R, which may be identical or different, are chosen from alkyl, aryl, aralkyl, alkaryl, alkene or organosilyl groups, optionally perfluorinated and optionally substituted with one or more carboxy, epoxy, hydroxyl, alkoxy, amino, halogen or sulfonic groups,
t equals 0 or 1.

According to a particular embodiment of the invention, the monomers used are preferably hydrophobic monomers.

It should be noted that, as ethylenically unsaturated monomers, use is preferably made of at least one monomer chosen from styrene or derivatives thereof, butadiene, chloroprene, (meth)acrylic esters, vinyl esters and vinyl nitriles. According to a particular embodiment, the monomer is chosen so as to give a water-insoluble, film-forming polymer.

The latex can be obtained by free-radical polymerization of the monomers in the presence of a free-radical polymerization initiator. This initiator may be chosen from the conventional initiators used in free-radical polymerization. It may, for example, be one of the following initiators:
hydrogen peroxides such as: tert-butyl hydroperoxide, cumene hydroperoxide, tert-butyl peroxyacetate, tert-butyl peroxybenzoate, tert-butyl peroxyoctoate, tert-butyl peroxyneodecanoate, tert-butyl peroxyisobutyrate, lauroyl peroxide, tert-amyl peroxypivalate, tert-butyl peroxypivalate, dicumyl peroxide, benzoyl peroxide, potassium persulfate or ammonium persulfate,
   azo compounds such as: 2,2′-azobis(isobutyronitrile), 2,2′-azobis(2-butanenitrile), 4,4′-azobis(4-pentanoic acid), 1,1′-azobis(cyclohexanecarbonitrile), 2-(tert-butylazo)-2-cyanopropane, 2,2′-azobis[2-methyl-N-(1,1)-bis(hydroxymethyl)-2-hydroxyethyl] propionamide, 2,2′-azobis(2-methyl-N-hydroxyethyl] propionamide, 2,2′-azobis(N,N′-dimethyleneisobutyramidine) dichloride, 2,2′-azobis(2-amidinopropane) dichloride, 2,2′-azobis (N,N′-dimethyleneisobutyramide), 2,2′-azobis(2-methyl-N-[1,1-bis(hydroxymethyl)-2-hydroxyethyl] propionamide), 2,2′-azobis(2-methyl-N-[1,1-bis(hydroxymethyl)ethyl] propionamide), 2,2′-azobis[2-methyl-N-(2-hydroxyethyl) propionamide or 2,2′-azobis(isobutyramide) dihydrate,
   redox systems comprising combinations such as:
   mixtures of hydrogen peroxide or alkyl peroxide, peresters, percarbonates and the like and of any one of the salts of iron, titanous salts, zinc formaldehyde sulfoxylate or sodium formaldehyde sulfoxylate, and reducing sugars,
   alkali-metal or ammonium persulfates, perborates or perchlorates in combination with an alkali-metal bisulfite, such as sodium metabisulfite, and reducing sugars,
   alkali-metal persulfates in combination with an arylphosphinic acid, such as benzenephosphonic acid and other similar acids, and reducing sugars.

The polymerization reaction takes place conventionally.

It is carried out in the presence of a nonionic or anionic surfactant chosen from alkoxylated mono-, di- or trialkylphenols, alkoxylated mono-, di- or tristyrylphenols, alkoxylated fatty alcohols and ammonium or alkali-metal salts of C₈-C₁₂ alkyl sulfates, alkoxylated sulfated fatty alcohol semiesters, C₁₂-C₁₈ alkyl sulfonate esters, etc.

The polymerization temperature is also conventional. By way of illustration, the temperature is between 50 and 120° C., more particularly between 70 and 100° C.

A latex made up of an aqueous dispersion of water-insoluble polymers is thus obtained, the polymer being in the form of particles possibly ranging between 10 nm and 5 μm in size.

The latex with modified surface chemistry of the present invention is obtained by addition, to this aqueous dispersion of water-insoluble polymers, of a water-soluble amphiphilic copolymer described above. The mixing of the latex with the water-soluble amphiphilic copolymer is carried out conventionally, for example using a blade mixer, by introducing the latex into a solution of copolymer, with agitation. The latex is preferably a dispersion of polymer containing from 20 to 70% by weight of solids. The solution of water-soluble amphiphilic copolymer has a solids content generally between 1 and 40% by weight.

According to a particular embodiment, the mixing may be followed by heat treatment at a temperature of between 50° C. and 100° C.

The amount of water-soluble amphiphilic copolymer introduced into the dispersion to form the latex of the invention is preferably between 0.01 and 20% by dry weight relative to the weight of insoluble polymer in the form of particles, preferably 1 to 10%.

According to a particular embodiment, the insoluble polymer in the form of particles is obtained from styrene and butadiene monomers; and the water-soluble amphiphilic copolymer is a copolymer comprising a hydrophilic block obtained from hydrolyzed ethyl acrylate and a hydrophobic block obtained from styrene. In this case, the amount of water-soluble amphiphilic copolymer introduced into this latex is preferably between 1 and 5%.

The pH of the latex of the present invention is defined as a function of the nature of the water-soluble amphiphilic copolymer, of the nature of the latex and of the application envisioned. It is in particular necessary to choose an amphiphilic copolymer which will be soluble at the pH under the conditions of the use of the latex.

A latex with surface properties modified by a water-soluble amphiphilic copolymer is thus obtained. When it is introduced into the latex, the water-soluble amphiphilic copolymer interacts with the surface of the particles of insoluble polymer such that the colloidal stability of the mixture is improved.

The latexes with surface properties modified by addition of water-soluble amphiphilic copolymers of the present invention can advantageously be used in formulations intended for applications in the field of papermaking coating, paints and construction materials.

In particular, when these latexes with modified surface properties are intended for applications in the field of papercoating for offset printing, it is particularly advantageous to use a latex with modified surface properties in which the water-insoluble, film-forming polymer has a glass transition temperature Tg below 15° C., preferably below 5° C., measured by DSC. Specifically, it has been noted that the paper-making coats obtained using a latex with modified surface properties exhibit a better binding power under wet conditions. In particular, the paper-making formulations obtained using this latex with modified surface properties exhibit, once deposited on the surface of the paper and dried, better resistance under wet conditions.

The following examples illustrate the invention without, however, limiting the scope thereof.

### EXAMPLES

In the examples which follow:
Mₙ represents the number-average molecular mass of the polymers; Mₙ is expressed in polystyrene equivalents (g/mol),
Mw represents the weight-average molecular mass of the polymers measured by GPC with THF as elution solvent, and using polystyrene as a standard.

For all the examples which follow, the polymerizations are carried out at a monomer conversion rate of greater than 95%.

### Example 1

### Synthesis and Hydrolysis of a Poly(Styrene)-b-Poly(Acrylic Acid) Amphiphilic Diblock Copolymer

1.1 Synthesis of the Block which is Hydrophobic in Nature

The polymerization is carried out under emulsion conditions, in a jacketed reactor equipped with a stainless steel three-bladed stirrer. 1178 g of water and 25.36 g of dodecyl sulfate (Texapon K12/96) are introduced at ambient temperature at vessel heel. The mixture obtained is stirred for 30 minutes (175 rpm) under nitrogen. The temperature is then raised to 85° C., and then 1.55 g of ammonium persulfate (NH₄)₂S₂O₈ in 2.48 g of water are incorporated.

Simultaneously, the addition of a mixture comprising the following is begun:
248 g of styrene (St),
13.95 g of methacrylic acid (AMA),
13.95 g of 2-hydroxyethyl methacrylate (HEMA), and
7.44 g of methyl α-(o-ethylxanthyl)propionate (CH₃CHCO₂Me)SCSOEt (compound of formula IA).

The addition lasts 55 minutes. Fifteen minutes after the start of the addition of the mixture comprising the comonomers and the methyl α-(o-ethylxanthyl)propionate, the addition of 0.56 g of sodium carbonate Na₂CO₃ dissolved in 100 g of water is begun. The latter addition is carried out over 45 minutes.

After complete addition of the various ingredients, a polymer in emulsion (latex) is obtained, which is maintained at 85° C. for one hour. After cooling to ambient temperature, 91 g of the polymer emulsion are taken for analysis.

The polymer obtained is a random copolymer of styrene, methacrylic acid and HEMA containing mainly styrene units.

The analytical results are as follows:
Mₙ=10300 g/mol
M_{w}/Mₙ=2.1

1.2. Synthesis of the Diblock Copolymer

Starting with the copolymer in emulsion previously obtained in Example 1.1, the following are added at 85° C., over one hour:
308 g of ethyl acrylate (EtA),
16 g of methacrylic acid (MAA), and
0.94 g of Na₂CO₃ diluted in 100 g of water.

The system is maintained at this temperature for a further two hours. 1.46 g of tert-butyl perbenzoate are subsequently added. 0.59 g of erythorbic acid diluted in 47 g of water is then introduced over one hour (until the end of the reaction).

After cooling to ambient temperature, the copolymer obtained is analyzed. The analytical results are as follows:
pH=5.7
Mₙ=17800 g/mol
M_{w}/Mₙ=1.75

The copolymer is a copolymer containing a mainly styrene block and a block of ethyl acrylate; the solution contains 28.5% of solids.

1.3. Hydrolysis of Diblock Copolymer

The hydrolysis is carried out in the same reactor for synthesis as that of Example 1.2. The following are introduced therein:
200 g of the copolymer of Example 1.2, expressed as solids (702.4 g at 28.5%),
1900 g of water (to adjust the solids at 10% by weight at the end of hydrolysis).

The pH is then adjusted to a value of 8 with 1N sodium hydroxide. The temperature is brought to 90° C. The reaction is carried out under nitrogen.

528 g of 2N sodium hydroxide (corresponding to one molar equivalent of sodium hydroxide relative to the ethyl acrylate) are added over 1 hour, with vigorous stirring (160 rpm). After complete addition of the sodium hydroxide, the reaction is maintained under these conditions for 11 hours.

The degree of hydrolysis of the acrylate units is measured, by proton NMR, as 88 mol %.

The product recovered at the end of the reaction is a translucent gel containing a water-soluble amphiphilic copolymer containing a mainly styrene block and a block comprising acrylic acid units.

### Example 2

The dispersion of Example 1 containing the water-soluble amphiphilic copolymer is diluted to 5%. This dilute dispersion is added to a Rhodopas® SB 023 latex marketed by Rhodia, consisting of a latex of styrene (59%) butadiene (37%) stabilized by carboxylic acids having a Tg of the order of 0° C., measured by DSC, according to amounts which make it possible to obtain the values specified in the table below. The pH of the mixture is adjusted to 8.5 by adding sodium hydroxide (M). The mixture is then heated in a waterbath for 10 min at 100° C.

A solution of carboxymethyl cellulose (CMC), known to destabilize latex, is added to this mixture in order to obtain a dispersion containing 0.2% by weight of CMC (relative to the total weight of dispersion).

An amount of water is added to the mixture in order to obtain a solids content of 10% by weight relative to the weight of dispersion.

The same latex is prepared without heat treatment.

The stability of the latex is evaluated by measuring the reflectance after addition to the dispersion of a fixed amount of a blue dye. This reflectance is measured using a Datacolor calorimeter. The higher the reflectance, the more homogeneous and therefore the more stable the system.

The results are given in Table 1.

TABLE 1

| % Diblocks | % reflectance |
|---|---|
| 0 | 17.8 |
| 0.66 | 20.2 |
| 3.33 | 21.5 |
| 6.66 | 22.8 |
| 13.3 | 25.6 |

These examples show that addition of the PS-PAA copolymer makes it possible to increase the stability of the dispersion. The results obtained with the dispersion having undergone heat treatment are of the same order as those given in Table 1.

### Example 3

In this example, a hydrophilic single-block polymer is prepared by polymerization of acrylic acid, in acetone. A water-soluble, nonamphiphilic polymer of acrylic acid, with Mn=5000, is thus obtained. This hydrophilic polymer is introduced into a dispersion of latex according to the process described in Example 2, without heat treatment. The latex is conditioned by adding 0.2% of CMC. The reflectance of the system is measured under the same conditions as previously.

The results are given in Table 2 below.

TABLE 2

| % PAA single-block | Reflectance (%) |
|---|---|
| 0% | 20 |
| 0.4% | 20 |
| 2% | 20.5 |

These results show that addition of a water-soluble PAA single-block polymer does not modify the stability of the dispersion.

### Example 4

A series of water-soluble amphiphilic copolymers is prepared according to the process of Example 1, by varying the amount of acrylic acid monomers. A series of copolymers for which the mass ratio of the hydrophilic block to the hydrophobic block ranges between 0.5 and 5 is thus obtained. The size of the blocks is measured by GPC. These block copolymers are added to the latex according to the process of Example 2, in an amount such that a solution at 3% of solids/latex solids is obtained.

These water-soluble amphiphilic copolymers do not exhibit any surfactant properties.

The results are given in Table 3 below.

TABLE 3

| Ratio of PAA/PS blocks | Reflectance (%) |
|---|---|
| 0.5 | 21 |
| 0.6 | 19 |
| 0.69 | 21.5 |
| 1.50 | 24.5 |
| 4.82 | 25 |

These results show that the stability of the dispersion is improved when the PAA/PS ratio increases.

### Example 5

In this example, a copolymer comprising PS-PAA blocks, the PAA/PS ratio of which is equal to 1.5, is added to a Rhodopas® SB 023 latex as previously described, in an amount such that the latex with modified surface properties contains 3% by weight of block copolymer.

A dispersion which contains 10 parts of this latex with modified surface properties and 100 parts by weight of kaolin is then prepared. The pH of the dispersion is adjusted to 8.5.

This dispersion is applied to a SIBILLE paper with a weight/unit area of 80 g/m². The formulation mentioned above is then deposited onto the paper using a threaded rod for depositing a coat which, after drying, has a weight/unit area of 20 g/m², and then the combination is dried for 10 min at 70° C.

The measurement consists in printing a strip of paper, prewetted with a water-distributing roller, under constant pressure, at a rate of 1 m/s, with an ink (Lorilleux 3801). The loss of optical density due to the appearance of pickpoints makes it possible to quantify the wet pick. The ratio WPR=10*(optical density of the wetted paper)/(optical density of the dry paper) is determined.

The higher this ratio, the better the resistance to wet pick of the coat deposited on the surface of the paper. Given in the table below are the values for the ratio of WPR with a latex with modified surface properties to the WPR with a nonmodified latex.

The same experiment is carried out with a Rhodopas® SB 852 latex marketed by Rhodia, containing styrene (69%) and butadiene (27%), the glass transition temperature of which is 20° C. measured by DSC.

The results are given in the table below.

TABLE 4

| | WPR (modified |
|---|---|
| Tg of the polymer | latex)/WPR(latex) |
| 0° C. | 1.3 |
| 20° C. | 0.5 |

These examples show that the binding power under wet conditions is improved for a latex consisting of an insoluble polymer having a Tg of the order of 0° C.

1-17. (canceled)

18. A latex with modified surface properties made by the process comprising the step of adding a water-soluble amphiphilic copolymer to an aqueous dispersion of a water-insoluble polymer obtained from monomers comprising ethylenic unsaturations, wherein the water-soluble amphiphilic copolymer is non-surfactant and is a block copolymer comprising a block which is hydrophilic in nature and a block which is hydrophobic in nature and wherein the hydrophilic block has a number-average molecular mass and the hydrophobic block has a number-average molecular mass with a ratio of the number-average molecular mass of the hydrophilic block to the number-average molecular mass of the hydrophobic block greater than or equal to 1, and wherein said amphiphilic bock copolymer corresponds to one of the following formulae:
S═C(Z¹¹(R¹¹)ₓ)—S-[A]-R¹² (Ip)
wherein:
Z¹¹ represents C, N, O, S or P,
R¹¹ and R¹², which are identical or different, represent:
(i) an optionally substituted alkyl, acyl, aryl, alkene or alkyne group,
(ii) an optionally substituted, saturated or unsaturated, or aromatic, carbon-based ring, or
(iii) an optionally substituted, saturated or unsaturated heterocycle,
x corresponds to the valency of Z¹¹ or x equals 0 and, in this case, Z¹¹ is R¹¹; and
A represents a polymer chain comprising a block which is hydrophilic in nature and a block which is hydrophobic in nature; 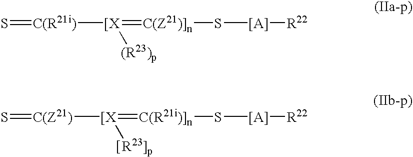
in which formulae (IIa-p) and (IIb-p):
X represents N, C, P or Si,
R²² represents:
(i) an optionally substituted alkyl, acyl, aryl, alkene or alkyne group, or
(ii) an optionally substituted, or aromatic, saturated or unsaturated, carbon-based ring, or
(iii) an optionally substituted, or aromatic, saturated or unsaturated, heterocycle,
Z²¹, R²¹ⁱ and R²³, which are identical or different, represent:
a hydrogen atom,
an optionally substituted alkyl, acyl, aryl, alkene or alkyne group,
an optionally substituted, or aromatic, saturated or unsaturated, carbon-based ring,
an optionally substituted, saturated or unsaturated, heterocycle, alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl or organosilyl groups, R representing an alkyl or aryl group, and
groups exhibiting a hydrophilic or ionic nature,
n>0,
I ranges from 1 to n,
p equals 0, 1 or 2 depending on the valency of X
in addition,
if X═C, then Z²¹ is not an S-alkyl or S-aryl group,
the group R^{21I}, with I=n, is not an S-alkyl or S-aryl group, and
A represents a polymer chain comprising a block which is hydrophilic in nature and a block which is hydrophobic in nature;
S═C(Z⁴¹)—[C≡C]ₙ—S-[A]-R⁴¹ (IVp)
in which formula:
R⁴¹ represents:
(i) an optionally substituted alkyl, acyl, aryl, alkene or alkyne group, or
(ii) an optionally substituted, or aromatic, saturated or unsaturated, carbon-based ring, or
(iii) an optionally substituted, or aromatic, saturated or unsaturated, heterocycle,
Z⁴¹ represents:
a hydrogen atom,
an optionally substituted alkyl, acyl, aryl, alkene or alkyne group,
an optionally substituted, or aromatic, saturated or unsaturated, carbon-based ring,
an optionally substituted, saturated or unsaturated, heterocycle, alkoxycarbonyl or aryloxycarbonyl (—COOR), carboxy (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxy (—OH), amino (—NR₂), halogen, allyl, epoxy, alkoxy (—OR), S-alkyl, S-aryl or organosilyl groups, R representing an alkyl or aryl group, or
groups exhibiting a hydrophilic or ionic nature,
n>0, and
A represents a polymer chain comprising a block which is hydrophilic in nature and a block which is hydrophobic in nature; or
S═C(OR⁵¹)—S-[A]-R⁵² (Vp)
wherein:
R⁵¹ represents: 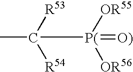
wherein:
R⁵³, R⁵⁴, which are identical or different, are halogen, ═O, ═S, —NO₂, —SO₃R, NCO, CN, OR, —SR, —NR₂, —COOR, O₂CR, —CONR₂ or —NCOR₂ groups, with R representing a hydrogen atom or an alkyl, alkenyl, alkynyl, cycloalkenyl or cycloalkynyl radical, an aryl radical optionally condensed with an aromatic or nonaromatic heterocycle, or an alkylaryl, aralkyl or heteroaryl radical; these radicals are optionally substituted with one or more groups, which are identical or different, selected from the group consisting of halogens, ═O, ═S, OH, alkoxy, SH, thioalkoxy, NH₂, mono- or dialkylamino, CN, COOH, ester, amide and CF₃, optionally interrupted by one or more atoms chosen from O, S, N and P; or from a heterocyclic group optionally substituted with one or more groups as defined above;
or R⁵³ and R⁵⁴ form, together with the carbon atom to which they are attached, a hydrocarbon-based ring or a heterocycle;
R⁵³, R⁵⁶, which are identical or different, represent a group as defined above for R; or together form a C₂-C₄ hydrocarbon-based chain optionally interrupted by a hetero atom chosen from O, S and N;
R⁵² has the same definition as that given for R⁵³; and
A represents a polymer chain comprising a block which is hydrophilic in nature and a block which is hydrophobic in nature.

19. The latex as claimed in claim 18, wherein the water-soluble amphiphilic copolymer has a molecular mass between 5 000 and 30 000 g/mol the molar masses being measured by steric exclusion chromatography in THF.

20. The latex as claimed in claim 18, wherein the hydrophilic block contains hydrophilic units in a proportion of greater than 25% by weight relative to the total weight of units in the hydrophilic block.

21. The latex as claimed in claim 18, wherein the hydrophobic block contains hydrophobic units in a proportion of greater than 50% by weight relative to the weight of units of the block which is hydrophobic in nature.

22. The latex as claimed in claim 18, wherein the polymer comprising an ethylenic unsaturation is obtained from ethylenically unsaturated monomers selected from the group consisting of:
CXdX′d(═CVd-CV′d)ₜ═CH₂, wherein
Xd and X′d, which are identical or different, represent: H, an alkyl group or a halogen,
Vd and V′d, which are identical or different, represent H, a halogen or an R, OR, OCOR, NHCOH, OH, NH₂, NHR, N(R)₂, (R)₂N+O—, NHCOR, CO₂H, CO₂R, CN, CONH₂, CONHR and CONR₂ group, wherein R, which are identical or different, are alkyl, aryl, aralkyl, alkaryl, alkene or organosilyl groups, optionally perfluorinated and optionally substituted with one or more carboxy, epoxy, hydroxyl, alkoxy, amino, halogen or sulfonic groups, and
t equals 0 or 1.

23. The latex as claimed in claim 22, wherein the ethylenically unsaturated monomer(s) is(are): styrene, styrene derivatives, butadiene, chloroprene, (meth)acrylic esters or vinyl nitriles.

24. The latex as claimed in claim 18, wherein the water-insoluble polymer has a Tg below 15° C.

25. A formulation intended for applications in the fields of papermaking coating, paints or construction materials, comprising the latex with modified surface property as claimed in claim 18.

26. The latex as claimed in claim 18, wherein the amphiphilic bock copolymer corresponds to formula (IVp).
